(19) United States
(12) Patent Application Publication
(10) Pub. No.: US 2003/0061134 A1
(43) Pub. Date: Mar. 27, 2003

(54) Electronic time registration system

(76) Inventors: Ralph Kofoed, Hornslet (DK); Albrecht Reimann, Ega (DK); Rene Larsen, Hornslet (DK)

Correspondence Address: CANTOR COLBURN, LLP, 55 GRIFFIN ROAD SOUTH, BLOOMFIELD, CT, 06002

(21) Appl. No.: 10/149,217

(22) PCT Filed: Dec. 6, 2000
(86) PCT No.: PCT/DK00/00670

(30) Foreign Application Priority Data
Dec. 9, 1999 (DK) PA 1999 01767

(51) Int. Cl. G06F 17/60

(52) U.S. Cl. 705/32

(57) ABSTRACT

The invention relates to an electronic time registration system comprising at least two computers connected in a computer network, wherein at least one primary computer comprises at least one primary time generator, and at least one secondary computer comprises at least one secondary time generator, wherein each secondary computer furthermore comprises a user interface comprising a device for activating and deactivating a time registration, wherein the activation of the device for a computer results in activation of a secondary time registration in dependency of the computer's secondary time generator and a primary time registration, where activation of the device further results in a current visual time indication of a secondary time registration on the user interface, wherein deactivation of the time registration of the computer by means of the device of the computer for activation and deactivation results in a primary time registration stored in the appropriate storage device, and wherein the deactivation also results in deactivation of the secondary time registration.

The invention relates to an electronic time registration system, electronic storage means and a method to be used in an electronic time registration system.

Previously, registration of a person's time spent on a given activity took place by the person writing down on a piece of paper the time of day, time spent and the nature of the activity etc. Naturally, this has been necessary for all types of activities for which it has been interesting to know the time spent thereupon.

A example of this is a company where each employee typically has many clients/customers. When any work is done on a particular case, it is necessary to know how much time is spent on the case in order to be able to bill the client/customer for the appropriate amount. Today, any work carried out is typically recorded on a note dedicated to the case, and time spent is currently entered on this note. Similarly, if more employees are working on the same case, it is necessary to have several notes which must be summed together in the end in order to provide a complete impression of the total amount of time spent on the case.

It is generally quite time-consuming for the individual employees to enter such information on the time registration notes relating to the particular cases as it requires quite a lot of writing for each activity. Also, it takes discipline and order to keep the notes completely updated if the time involved is quite limited for each case and at the same time involves many different cases.

At the same time, it is a labour extensive job if one type of activity is to be summed up, e.g. telephone conversations in a certain period of time, during the active part of the process. In order to gain such an overview, it is necessary to gather all these time registration notes from everybody involved in the case, locate the particular type of activity and subsequently sum up time spent thereupon. In practice, this is almost impossible to administer which means that a complete overview is often not available until time spent on a particular case is finally summed up in order to be able draw up an invoice.

The result of these drawbacks is often that the actual amount of time spent and registered in relation to the case is incomplete since the employee does not have the necessary amount of time to register time spent on the case available to him. At a later point, when the employee can find the necessary time to register the amount of time spent, it may be difficult to remember the correct amount of time or on which case the work was done. Often, the employee will completely forget that he has spent any time on a case which means that the client/customer will not be billed for the actual amount of time spent on his business with the company when an invoice is prepared.

This may not necessarily be in the favour of the client/customer as a sum-up of time spent often involves a more or less random addition of time. This is due to the fact that the employee often has the feeling that he has spent more time with a case than is actually registered. Also, the employee may have the need to have unspecified time transferred to time registered on a case to e.g. increase his billing amount and the result is therefore often that additional time is added to the client/customer's case.

This is unsatisfactory for the company by which the employee is employed as it makes it impossible for the company to account completely for time spent to the client/customer. This, in turn, will generate some insecurity with the client/customer who will not be able to determine whether he is paying for the actual amount of work done for him or not.

In order to improve use of the time registration notes, it is known to transfer these to corresponding electronic systems. In these systems, registration of time spent on a case will take place by entering this information on a computer which will show time spent on a computer screen instead of notes.

The advantages of such known electronic systems over paper are, among others, the opportunity to correct information entered and copy it to other areas on the computer screen. Also, electronic systems facilitate an improved sum-up process of e.g. time spent on certain activities since the information will often be stored in central data storage means.

The basic problems with time registration notes are, however, still present in relation to the known electronic time registration systems, since the electronic systems basically only offer a transfer from paper to a computer screen. Thus, it is still quite time-consuming for the employee to make the time registrations and the amount of time registered will therefore often not correspond to the actual amount of time spent on a case.

Electronic systems on network computers featuring a central time function are also known. This time function represents the time of all computers in a network and thereby takes care of all registrations of time centrally or decentrally.

Naturally, this has the immediate advantage that all computers have the same time function. However, there are several disadvantages of a completely centrally controlled system, including heavy traffic on the network in relation to use of the system which generally results in long response times for the individual computers using the network.

Also, a centrally controlled system may generate problems in relation to the individual computers since they cannot disconnect the connection to the central time function in relation to time registration. This means, among other things, that energy saving functions on the individual computers are not an option.

Correspondingly, the system is very sensitive to short interruptions between the central time function and the computers in the network. An interruption will basically mean that all computers in a network where time registration is taking place will show wrong values which cannot be altered.

### THE INVENTION

The invention in claim 1 relates to an electronic time registration system comprising at least two computers connected in a computer network, wherein at least one primary computer comprises at least one primary time generator, and at least one secondary computer comprises at least one secondary time generator, wherein each secondary computer furthermore comprises a user interface comprising a device for activation and deactivation of a time registration, wherein the activation of said device for a computer results in activation of a secondary time registration in dependency of the computer's secondary time generator and a primary time registration in dependency of the primary time generator, wherein activation of said device also results in a visual time indication of a secondary time registration on the user interface, wherein deactivation of the time registration means on the computer by means of the computer device for activation and deactivation results in a primary time registration which is stored in appropriate storage means, and wherein deactivation also results in deactivation of the secondary time registration.

In this manner, it is possible to ensure that the time registration system only transfers data from a secondary computer with a user interface to a primary computer by activating or deactivating the time registration. Hereby, a time registration system is created where the computer network is only loaded for a short period of time due to use of the system which generally leads to improved response time for the individual computers in the computer network.

Since the primary time generator is placed on the primary computer with data storage means and since it defines activation and deactivation times of the individual time registration means, there are no deviations between time registrations on different secondary computers.

As it is possible for everybody with access to the computer network to see all time registrations for all activities, it is correspondingly simple to make overviews of the time registrations relating to the individual activities or the like because the registrations of time taken from different user interfaces are both similar and accurate.

In other embodiments of the invention, it is possible to introduce limitations as to which time registrations may be seen by the individual user in the data storage means. Furthermore, the time registration system may be applied by an individual computer without access to a computer network. In this situation, the computer's own storage means will act as storage means for the individual time registrations of the activities and the time function of the computer will manage all time functions in the time registration system.

In this connection, it should be understood that the claim relating to deactivation time registration includes both permanent deactivation and a temporary deactivation after which the time registration system may once again be activated.

Also, it should be understood that the storage of values may take place by activation and subsequent deactivation or by a current update with or without storage of activation or deactivation values. The storage itself may take place in fixed data storage means or in a buffer from which the values may later be transferred to the fixed data storage means with or without intermediate processing of the values.

The values stored by the time registration may naturally be a period of time or a point in time defined by means of hours or the time of day. However, other options are also possible. This includes e.g. a count of a number of elements, each element representing a certain amount of time.

In this manner, it is possible to define various types of time where e.g. time registered at night or during the weekend is counted by elements of 3 minutes and regular working hours are counted in elements of 6 minutes. The number of elements may subsequently be billed to a client/customer by simple calculation involving a certain fixed price for each element.

When, as stated in claim 2, the device for activation and deactivation or a time registration is activated or deactivated by a computer input device, such as a computer mouse, it is easy for the user to activate or deactivate the time registration means by e.g. a single click on the mouse. As the user learns that it is very simple to use the time registration system, he will be more inclined to make the time registrations representing the actual time spent on the various activities.

It is also possible to use the time registration system where activation and deactivation take place solely by means of a keyboard. In this case, part of the user-friendliness of the invention will be lost as the devices for activation and deactivation of a given activity are placed on the user interface and continuous movement may thus not be obtained in the same manner made possible by e.g. a computer mouse.

When, as stated in claim 3, the data means for storage comprises a set of records, it is possible to create corresponding values for activation and deactivation to be stored in a record. In this manner, the stored values will appear as a set of records with the same build-up which increases the possibility of generating overviews and the like where many time registrations are involved in a simple manner.

When, as stated in claim 4, each record is dedicated to an activity defined on the user interface, it is possible to generate overviews and the like where many time registrations are involved within the same activity in a simple manner.

When, as stated in claim 5, all records are stored separately in the data storage means, it is possible to generate very accurate overviews or the like of the individual user's time registrations at any time of day.

When, as stated in claim 6, chosen records are stored separately in the data storage means, the space which is occupied by these records in the data storage means may be limited as only a certain number of different records is necessary. As for the records which are not stored separately, the time registration values hereof will often be summed over a period of time and the summed value stored in a record.

When, as stated in claim 7, the values of all records relating to a given activity within a certain period of time are summed and stored in the data storage means, it is possible to limit the number of records to a minimum and thereby the amount of space occupied by these records in the data storage means. This is possible since only one record with the summed value per activity is needed in the permanent storage means. The period of time will often be a day, within which all time registrations for a certain activity will be summed together.

The invention in claim 8 comprises an electronic time registration system comprising at least two computers connected in a computer network, wherein at least one primary computer comprises at least one primary time generator, and at least one secondary computer comprises at least one secondary time generator, wherein each secondary computer furthermore comprises a user interface comprising a device for activation and deactivation of a time registration, wherein the activation of said device for a computer results in activation of a secondary time registration in dependency of the computer's secondary time generator and a primary time registration in dependency of the primary time generator, wherein activation of said device also results in a visual time indication of a secondary time registration on the user interface, and wherein one or more different graphic indication means placed on or in connection with the user interface indicates that an action is being made in the electronic time registration system.

In this manner, the user is provided with a very user-friendly system in which it is always possible to check the status of the time registration. This may include e.g. whether a time registration system is loaded into the computer memory, whether a time registration is currently being made or temporarily deactivated. These options are all shown by icons with individual characteristics and in places on the computer screen where they are always visible e.g. on the program line of the computer's operating system. Also, it is possible to have the individual icons indicate text relating to either an activity or an actual time registration action being carried out. Thus, the icons contribute to creating a user-friendly environment of the time regstration system which ensures use of the system and at the same time offers efficiency.

The icons will also carry a lot of importance in relation to other computer programs, as the time registration system will operate either entirely without being shown on the screen or behind the other programs on the computer screen and thereby not be entirely visible. Thus, the user will usually have to redisplay the time registration system on the screen from time to time to check the current status of the system. With these special icons representing the status possibilities it is easy for the user to determine the actual status of the time registration system. By indicating the status in this manner, a significantly reduced load on the computer processor and memory is obtained since it is often not necessary to input the user interface on the computer screen. This means that the user of the computer will not experience periods during which other programs cannot be accessed due to the fact that the computer is loading the user interface on the computer screen.

At the same time, it is possible to only have the visual time indication means of the secondary time registration on the user interface updated in case the user either has the user interface on his computer screen or redisplays it by means of the icons. In this manner, the computer processor will also be less loaded since it only has to update the user interface from time to time.

The invention in claim 10 comprises data storage means for corresponding with a computer, said storage means comprising a computer readable code for running an electronic time registration system according to claims 1 to 8 and a method of time registration according to claim 9, whereby an advantageous embodiment of the invention is obtained. The term “data storage means” includes discs, data tapes, CD-ROMs, RAM circuits and hard disks together with all other forms of storage means for data (data carrier).

### THE FIGURES

The invention will be described below with reference to the figures, in which

FIG. 1 shows an electronic time registration system

FIG. 2 shows an electronic time registration system according to the invention schematically

FIG. 3a shows a user interface for an electronic time registration system according to the invention

FIG. 3b shows a user interface with an activity in the activated state,

FIG. 3c shows a user interface with an activity in the deactivated state,

FIG. 4 shows a signature menu

FIG. 5 shows a report generator

FIG. 6 shows an outline of the program line,

FIG. 7 shows an outline of the program line with graphic indication means of an activated time registration.

### DETAILED DESCRIPTION

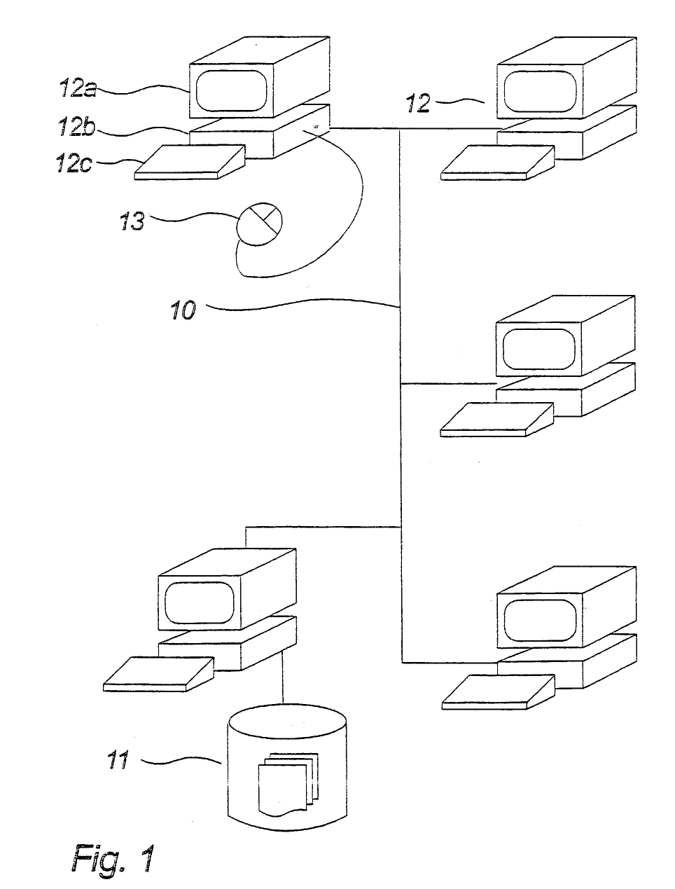

FIG. 1 shows an embodiment wherein several computers 12 with an electronic time registration system have been connected via a computer network 10 to data storage means 11. The storage means 11 will typically be part of a computer server also containing a primary computer time function.

Each individual computer 12 is traditionally constructed with a central unit 12b comprising a processor, decentral storage means and a decentral memory circuit, among other things. Also, each computer is provided with means of its own such as a computer time function or time generator. In addition, the computer is provided with a computer screen 12a and a keyboard 12c and a computer unit where the computer unit is represented by computer mouse 13 in this embodiment but could also be a track ball, a computer pen or a similar computer input device, including a keyboard.

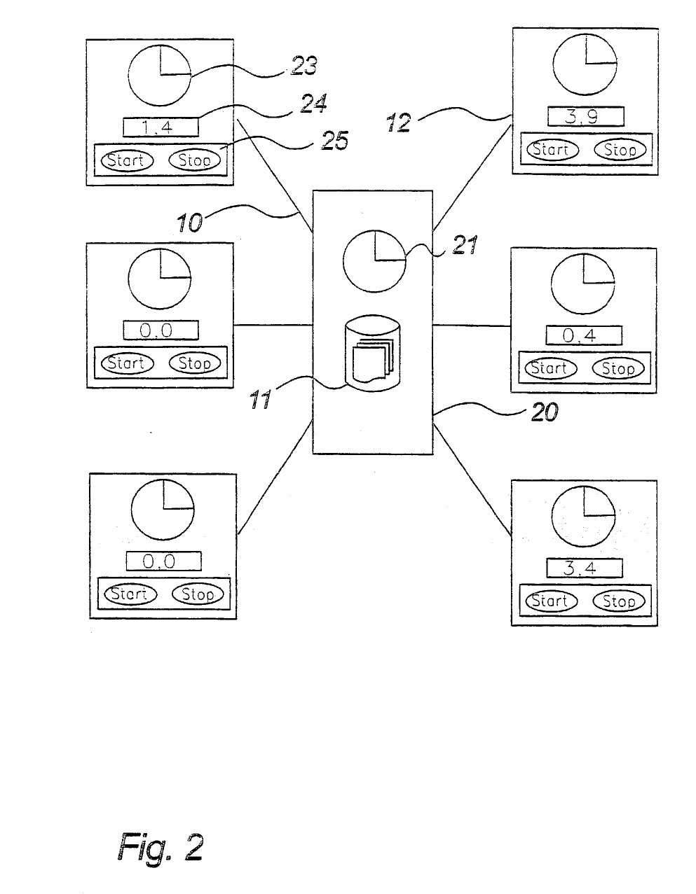

FIG. 2 shows the build-up of a time registration system according to the invention schematically, where a primary computer 20 comprises a primary time function 21 and data storage means 11. Also, a number of secondary computers have been shown which are connected to the primary computer through a computer network 10. Each of the secondary computers is provided with a secondary time function 23 which updates a section 24 on the user interface of the computer in question. The secondary computers also feature a device 25 for activating or deactivating time registration of the computer in question. The device is illustrated in the figure by means of a button. However, it is naturally also possible to have a button for each of the actions.

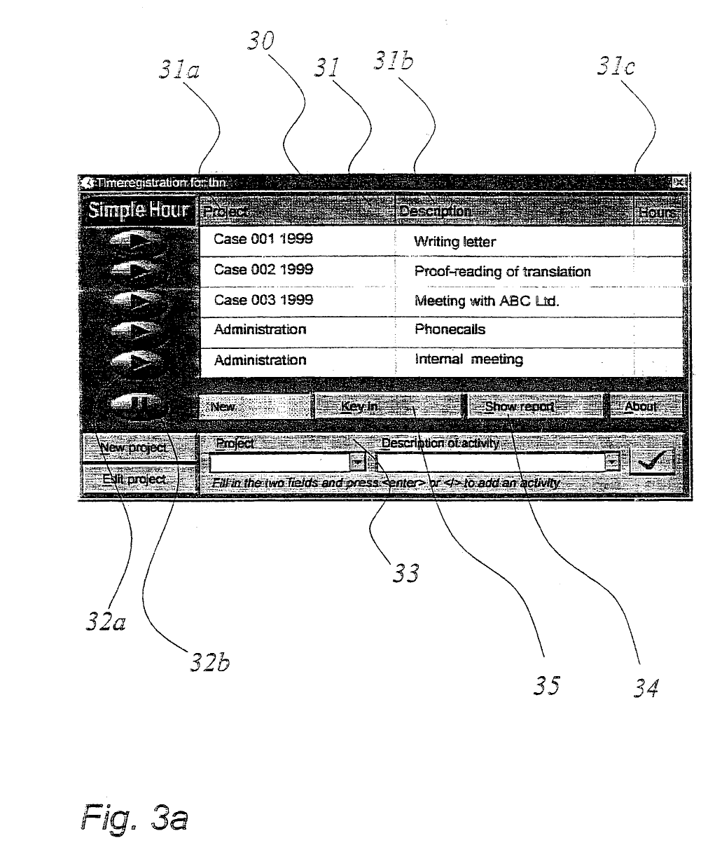

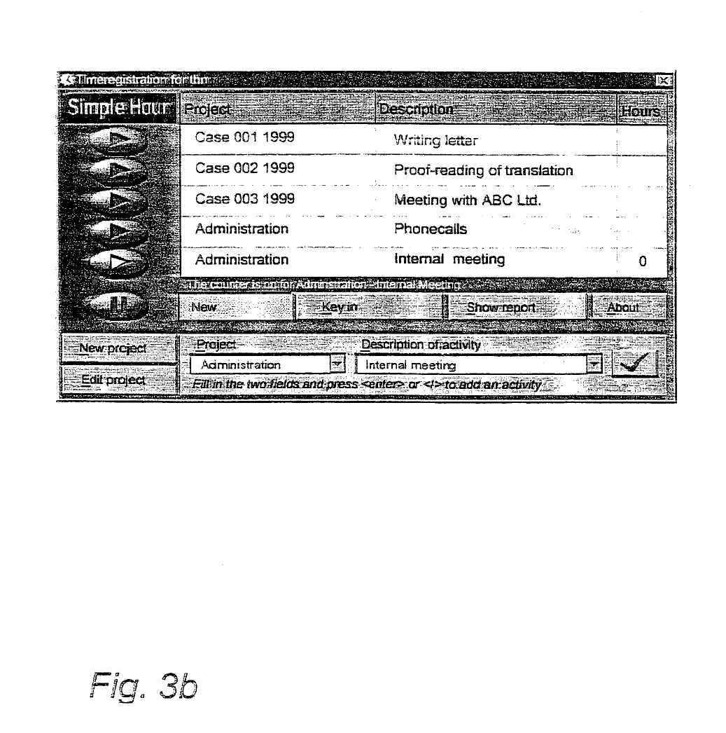

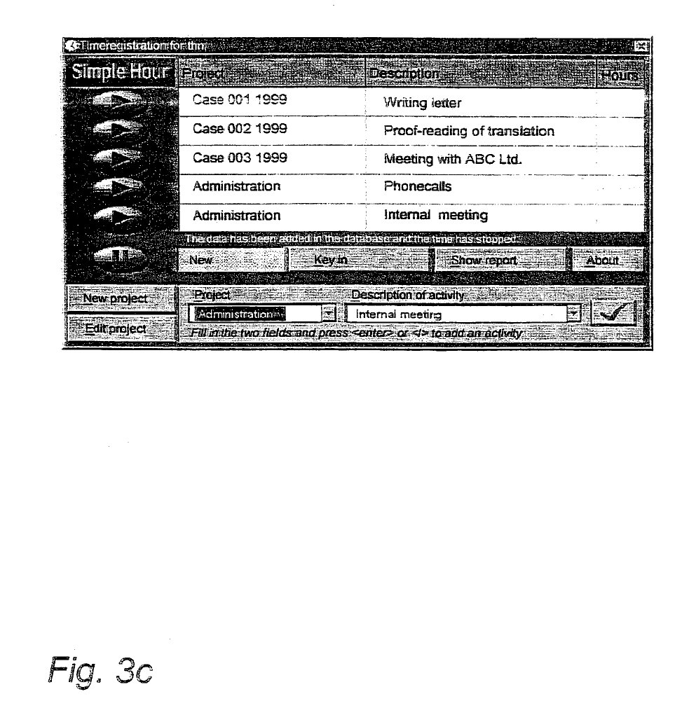

FIG. 3a shows a user interface 30 in the elecronic time registration system for a secondary computer where a user has the opportunity to activate or deactivate the time registration on an activity on the computer screen by means of one single command. The user interface 30 is connected to data storage means wherein values generated by means of time registered on a certain activity are stored in a record.

In connection with the storage of time registrations, only the values of the primary time function are stored in the data storage means. However, the individual computer's time function updates the time counter or indication means on the computer user interface 30.

The user interface 30 is constructed with an activity area 31, an activity panel 32 and a creation panel for creation of activities 33.

The activity area consists of a number of rows that have each been dedicated to an activity. A row is divided into several areas, wherein the name of the activity 31c is shown in the first area, a description of the activity is shown in the second 31b and the actual amount of time spent on an activity is shown in the third 31c if a time registration process is in progress for the activity.

The activity panel 32 comprises a number of buttons with a button 32a positioned in proximity of the associated activity. By pushing a button, the time registration means is activated for the associated activity and if pushed once again, the time registration means is deactivated. Also, the activity panel is provided with a pause button 32b which puts any time registration on an activity on standby until the pause button is once again pushed.

The creation panel 33 is used for creation of activities or for correction/adjustment of existing activities on the user interface. The panel does furthermore feature buttons 34, 35 for creating and displaying a report of values stored in the data storage means on the primary computer and for entering a time value directly in a record without using the rest of the user interface.

FIGS. 3b and 3c show the time registration system in situations where time is registered on a certain activity and where the values are subsequently stored in a record in the data storage means, respectively.

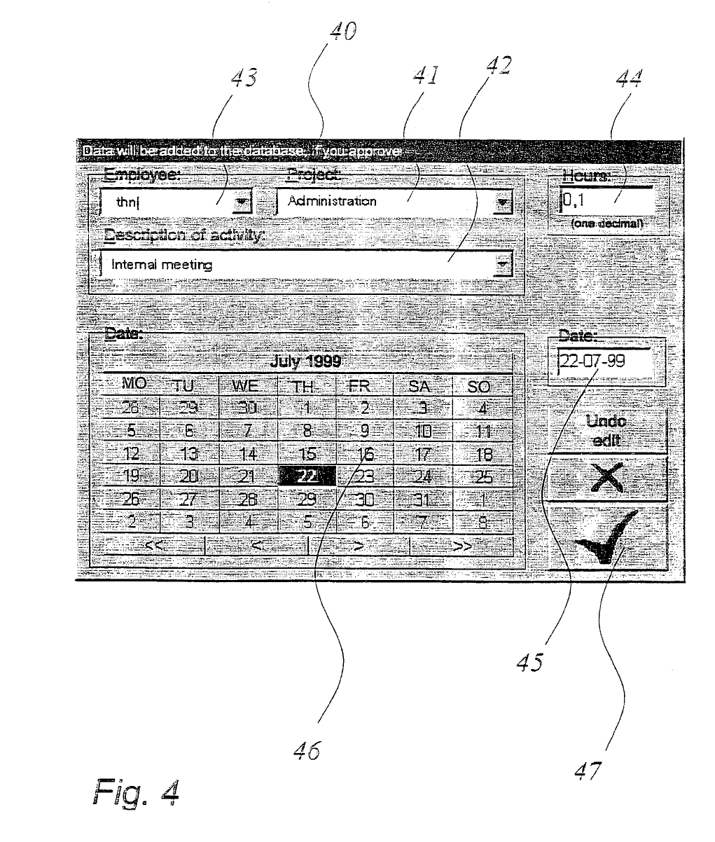

FIG. 4 shows a signature menu 40 which pops up on the user interface after the time registration system for a certain activity has been deactivated by pressing the stop button. The menu consists of a number of areas specifying the activity on which time spent 41 has been registered, incl. description of the activity 42, the user of the time registration system 43 and time registered from activation to deactivation 44. In addition, there may be an area specifying the actual date 45, and a calendar 46 which makes it possible to change the date by clicking on the correct date.

If so desired, the information in the various areas may be replaced or changed by entering new information. Once the information can be accepted, it is approved by clicking on an approval button 47, after which the information is transferred to a record in the data storage means.

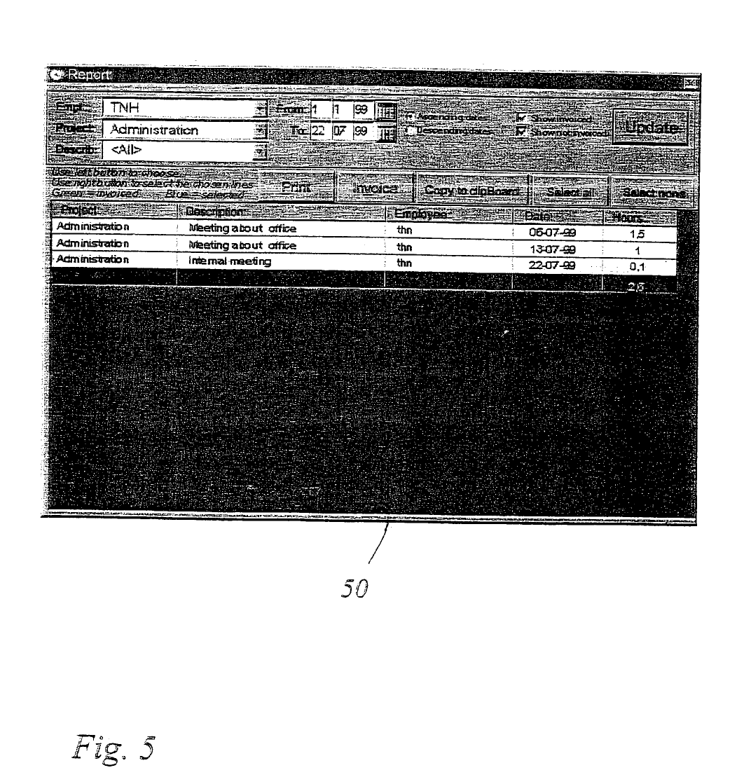

FIG. 5 shows a report generator 50 by which the individual records for one or more activities may be shown, incl. the registered time. The report generator can e.g. be used to bill the registered time by transferring the record in question to a separate computer file for billed time. Subsequent to this billing, the record will be provided with a colour different from that of the non-billed records in the report generator indicating that it has been invoiced. At the same time, it will no longer be possible to alter the contents of the billed record.

It is possible to export the contents of one or more records from the report generator to other programs, e.g. an arithmetic program, if it is relevant to generate statistics on the basis of the contents.

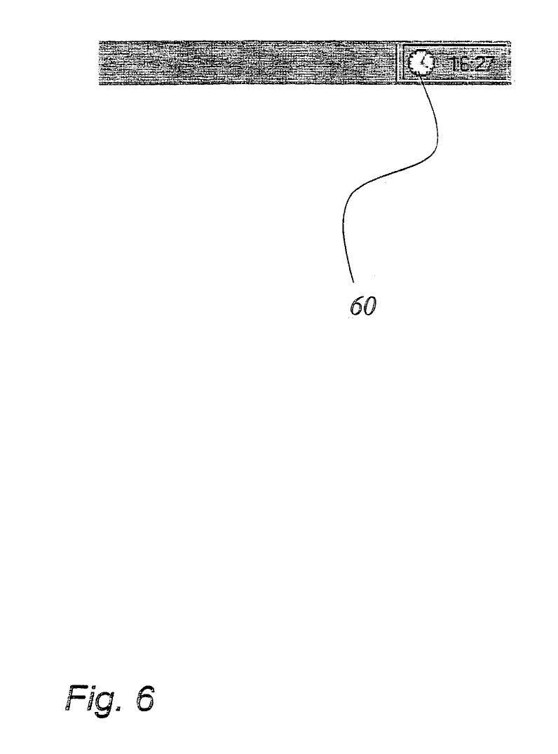

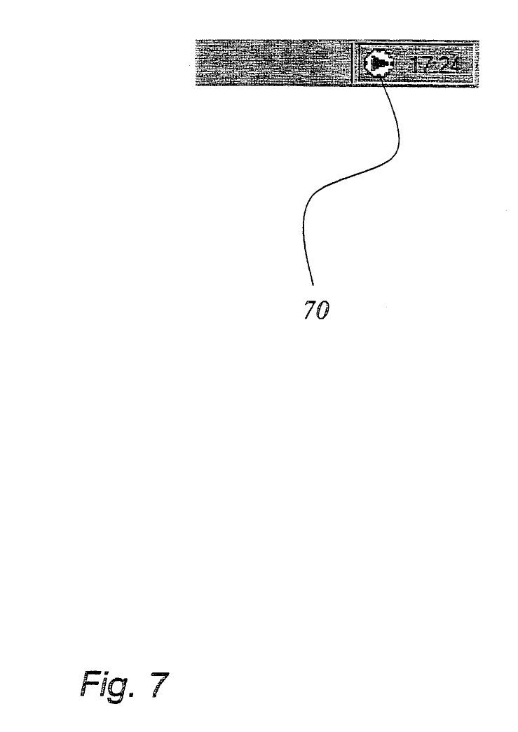

FIGS. 6 and 7 show examples of program lines where graphic indication means 60, 70 indicate to the user that the time registration system is loaded into the computer memory.

The graphic indication means furthermore makes it possible to maximise or redisplay the user interface of the time registration system if it has been minimized or is otherwise not visible of the computer screen. This may e.g. be relevant in situations where other programs are in use and fill the computer screen completely or partly.

The graphic indication means 70 shown in FIG. 7 also indicates that a time registration is being made on an activity. In case the user interface is not immediately accessible on the screen, a time registration may be activated, put on standby or deactivated by means of different key combinations on the computer keyboard. Apart from the graphic indication means shown in FIGS. 6 and 7, there is also a graphic indication for at situation where an activity is on standby.

List of Reference Numbers Relating to the Figures

10. computer network

11. data storage means

12. secondary computer

12a. computer screen

12b. central unit

12c. keyboard

13. computer input device

20. primary computer

21. primary time generator

23. secondary time generator

24. time area

25. device for activating or deactivating time registration

30. user interface on a computer

31. activity area

31a. name of activity

31b. description of activity

31c. current time indicator

32. activity panel

32a. activation button

32b. pause button

33. creation panel

34. button for showing a report

35. button for manual input

40. signature menu

41. activity

42. description of activity

43. user name

44. time registered from activation to deactivation

45. date area

46. calendar

47. approval button

50. report generator

60. graphic indication means (time registration—inactive)

70. graphic indication means (time registration—active)

1. Electronic time registration system comprising at least two computers connected in a computer network, wherein
at least one primary computer (20) comprises at least one primary time generator (21), and
at least one secondary computer (12) comprises at least one secondary time generator (23),
wherein each secondary computer (12) furthermore comprises a user interface (30) comprising a device for activation and deactivation of a time registration (25, 32a),
wherein the activation of said device for a computer results in activation of a secondary time registration in dependency of the computer's secondary time generator (23) and a primary time registration in dependency of the primary time generator (21),
wherein activation of said device also results in a visual time indication of a secondary time registration on the user interface (30),
wherein deactivation of the time registration means on the computer by means of the computer device for activation and deactivation (25, 32a) results in a primary time registration which is stored in appropriate storage means (11),
and wherein deactivation also results in deactivation of the secondary time registration.

2. Electronic time registration according to claim 1, wherein the device for activation and deactivation (25, 32a) of a time registration is activated or deactivated by a computer input device, such as a computer mouse (13).

3. Electronic time registration system according to claim 1, wherein the data means for storage (11) comprises a set of records.

4. Electronic time registration system according to claim 3, wherein each record is dedicated to an activity defined on the user interface (30).

5. Electronic time registration system according to claim 3, wherein all records are stored separately in the data storage means (11).

6. Electronic time registration system according to claim 3, wherein chosen records are stored separately in the data storage means (11).

7. Electronic time registration system according to claim 3, wherein the values of all records relating to a given activity within a certain period of time are summed and stored in the data storage means (11).

8. Electronic time registration system comprising at least two computers connected in a computer network (10), wherein
at least one primary computer (20) comprises at least one primary time generator (21), and
at least one secondary computer (12) comprises at least one secondary time generator (23),
wherein each secondary computer (12) furthermore comprises a user interface (30) comprising a device for activation and deactivation of a time registration (25, 32a),
wherein the activation of said device for a computer results in activation of a secondary time registration in dependency of the computer's secondary time generator (23) and a primary time registration in dependency of the primary time generator (21),
wherein activation of said device also results in a visual time indication of a secondary time registration on the user interface (30),
and wherein one or more different graphic indication means (60,70) placed on or in connection with the user interface (30) indicates that an action is being made in the electronic time registration system.

9. Method of time registration in an electronic time registration system according to claims 1 to 8.

10. Data storage means for corresponding with a computer, said storage means comprising a computer readable code for running an electronic time registration system according to claims 1 to 8 and a method of time registration according to claim 9.
